(19) United States
(12) Patent Application Publication
(10) Pub. No.: US 2026/0213847 A1
(43) Pub. Date: Jul. 23, 2026

(54) WIRELESS COMMUNICATION BETWEEN COMPUTE DIES IN AN OPTICAL COMMUNICATION NETWORK

(71) Applicant: Mellanox Technologies, Ltd., Yokneam (IL)

(72) Inventors: Elad Mentovich, Tel Aviv (IL); Juan Jose Vegas Olmos, Solroed Strand (DK)

(21) Appl. No.: 19/456,775

(22) Filed: Jan. 22, 2026

Related U.S. Application Data
(63) Continuation-in-part of application No. 19/035,428, filed on Jan. 23, 2025.

(51) Int. Cl. H04B 10/40; H04B 10/80

(52) U.S. Cl. CPC H04B 10/40; H04B 10/801

(57) ABSTRACT

A device comprising at least one processing device, the at least one processing device comprising a plurality of compute dies and a plurality of wireless transceivers, each wireless transceiver coupled to a respective one of the plurality of compute dies, wherein each wireless transceiver of the plurality of wireless transceivers is configured to wirelessly communicate with one or more other wireless transceivers of the plurality of wireless transceivers, enabling wireless communication between the plurality of compute dies. The device further comprises an optical transceiver configured to communicate with at least one compute die of the at least one processing device via at least one wireless transceiver of the plurality of wireless transceivers, and to optically communicate with one or more external devices.

### RELATED APPLICATION

This application is a continuation in part of U.S. application Ser. No. 19/035,428, filed on Jan. 23, 2025, the entirety of which is incorporated by reference herein.

### BACKGROUND

The present disclosure is related to co-packaged optics (CPO) and high-speed interconnects. In particular the present disclosure pertains to wireless communication between compute dies in an optical communication network.

In the field of computer hardware, a circuit package (henceforth also, just ‘package’) typically refers to an encapsulated assembly including multiple devices, which may include integrated circuits (ICs), passive components, and other elements. The package provides a shared housing, physical protection, and signaling connections to and between its components, among other things.

A package includes multiple electrical, optical, active, passive, and/or signal processing components. As the size of these components continues to shrink, making connections between them within the package becomes more challenging. Additionally, all traffic from the components within a package is communicated to outside components at the package level, meaning a component in one package (e.g., a compute die) is unable to directly communicate with a component in another package (e.g., another compute die).

Optical co-packaging refers to the integration of multiple optical components or devices of a circuit within a single package. Optical co-packaging enables compactness, efficiency, and improved performance in optical systems. By combining different optical elements such as lasers, photodetectors, waveguides, switches, and/or passive optical components into a single package, optical co-packaging can streamline manufacturing processes, reduce costs, and enhance system integration.

Optical co-packaging addresses the demand for high-speed and high-bandwidth optical communication systems. This demand arises from emerging applications in areas such as data centers, artificial intelligence model training and inference, telecommunications, and sensing technologies. By integrating various optical components into the same package, optical co-packaging can enable reduced signal losses, improved signal integrity, and enhanced thermal management.

Optical co-packaging may be implemented using various mechanisms, including wafer-level integration, flip-chip bonding, and hybrid integration. These techniques enable the alignment and connection of optical components within a compact package, while also facilitating efficient heat dissipation and reliable signaling interconnections.

The co-packaging of optical switches that use lasers or hard-wired links between a compute die (e.g., a central switch) and peripheral transceivers can lead to die layouts that increase rapidly in area as the port count and/or capacity per port of the switch increases.

Internal fiber-based interconnects between a compute die and peripheral transceiver chiplets can impose significant constraints on package design. Fiber connections require precise alignment during manufacturing, limit layout flexibility, and complicate replacement of individual chiplets. A wireless communication fabric for internal package interconnects can address these limitations while retaining optical fiber connections for external network interfaces.

### BRIEF DESCRIPTION OF THE DRAWINGS

FIG. 1 illustrates an example system, according to some aspects of the disclosure

FIG. 2 illustrates an exemplary server system according to some aspects of the disclosure.

FIG. 3 illustrates a network interface card according to some aspects of the disclosure.

FIG. 4 illustrates an example of a system including multiple network interface cards.

FIG. 5 illustrates an exemplary processing system in accordance with another embodiment.

FIG. 6 illustrates an exemplary computer system according to some aspects of the disclosure.

FIG. 7 illustrates a compute die of a package according to some aspects of the disclosure.

FIG. 8 illustrates a networking device according to some aspects of the disclosure.

FIG. 9 illustrates an exemplary co-packaging arrangement according to some aspects of the disclosure.

FIG. 10 and FIG. 11 illustrate an exemplary transceiver and exemplary optical switch according to some aspects of the disclosure.

FIG. 12 illustrates an exemplary data center according to some aspects of the disclosure.

FIG. 13 illustrates an example method, according to some aspects of the disclosure.

### DETAILED DESCRIPTION

In packages with both optical and electronic circuits, interconnection between transceivers and optical components (e.g., such as optical switches) can use optical fibers. Using optical fibers is an expensive connectivity solution. For example, the lasers used for these interfaces can draw substantial amounts of power. In another example, the physical space needed for fiber based connections can constrain the scalability of these solutions. In another example, stringent alignment requirements for fiber-based connections can constrain layout flexibility.

In packages that include a switch, implementing an effective high-speed interconnect between compute dies and other components of the package can increase the size of the package, can increase the cost and/or complexity of manufacturing the package (e.g., due to constraints on die or component placement), and can complicate replacement of adjacent damaged compute dies and/or components.

Aspects of the present disclosure address the above and other challenges by implementing wireless communication between compute dies and/or optical switch devices in an optical communication network. In some embodiments, a wireless communication fabric is used for internal interconnects while maintaining optical fiber connections for external network interfaces. In embodiments, the package includes a compute die, an optical switch, and one or more wireless chiplets. In some embodiments, the wireless chiplets include optical transceivers arranged at or around the periphery of the compute die. The wireless chiplets enable a wireless communication fabric that provides terahertz-range or millimeter-wave interconnects between the compute die and the wireless chiplets, between different wireless chiplets, and/or between other components. Optical fiber interconnects may couple the wireless communication fabric of the package to an external optical network. In some embodiments, the wireless chiplet(s) is/are mechanically decoupled from the compute die, meaning no physical waveguides or fibers bridge the gap between them. The implementation of this wireless communication fabric enables easier compute die and component placement and relaxed alignment tolerances during manufacturing. Layout flexibility and port scalability is enabled by way of the wireless communication fabric interfacing the compute die to the wireless chiplets and/or interfacing the wireless chiplets to one another. In some embodiments, the wireless communication fabric between the transceivers and the compute die can use terahertz-range or millimeter-wave frequencies (20 GHz to 10 THz), which may provide effective bandwidth on par with optical fiber interconnects.

Advantages of the present disclosure include a flexible coupling solution that decouples the internal package interconnects from the external optical network connections. The mechanically decoupled (floating) wireless chiplets can facilitate replacement or reconfiguration of individual chiplets, such as faulty or poorly-performing transceivers, without disturbing adjacent components. The wireless communication fabric can also simplify alignment during package assembly since precise fiber-based connections to the compute die may not be required. Additionally, the wireless communication fabric can reduce the use of opto-electronic converters within the package, saving power consumption while maintaining high-bandwidth optical connections to the external network.

In some embodiments, terahertz-range communication can use highly directional antennae, reducing the likelihood of crosstalk between wireless channels. The available spectrum for short-range (e.g., centimeter-scale) terahertz communication is more than adequate to provide sufficient channel separation that avoids crosstalk. Additionally, pre-calibration of the transceivers in the package may be performed to identify a combination of wireless channels for each that provides a lowest bit error rate (BER).

The power and circuit area savings described above can also arise from the use of terahertz-range wireless signaling over distances in a range of a few centimeters, such as between adjacent packages on a same plane in a data center rack, or between packages or data processing units on vertically-adjacent racks. In some embodiments, the wireless communication fabric extends beyond intra-package links to short-range chip-to-chip, tray-level, and/or rack-adjacent communication where line-of-sight paths and directional antennas are practical.

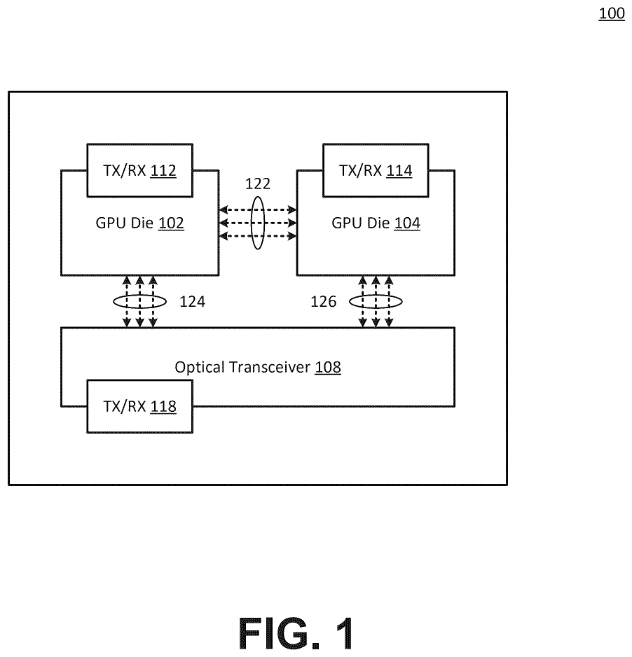

FIG. 1 illustrates an example system 100, according to some aspects of the disclosure. The system 100 represents a co-packaged arrangement where GPU dies and optical transceivers communicate via wireless interconnects, enabling flexible communication topologies that may not be achievable with traditional wired interconnects.

The system 100 includes a GPU die 102, a GPU die 104, and an optical transceiver 108. The GPU die 102 is coupled with a wireless transceiver 112, the GPU die 104 is coupled with a wireless transceiver 114, and the optical transceiver 108 is coupled with a wireless transceiver 118. In some embodiments, the GPU dies 102, 104 may be part of a multi-die processing device or chiplet architecture where each die is a standalone functional unit capable of independent operation.

In some embodiments, the GPU die 102 communicates with the GPU die 104 via signals 122. In some embodiments, the signals 122 are wireless signals that are sent between the wireless transceiver 112 and the wireless transceiver 114, respectively. In some embodiments, the signals 122 are electrical or optical signals that are sent via electrical or optical routes between the GPU dies 102, 104. The signals 122 enable direct chip-to-chip communication between the GPU dies 102, 104 without requiring the signals to pass through the optical transceiver 108, which may reduce latency and power consumption for intra-package communication.

In some embodiments, the GPU dies 102, 104 communicate with the optical transceiver 108 via the signals 124, 126, respectively. These signals may be wireless, electrical, or optical. Wireless signals are sent between the wireless transceivers 112, 114 and the wireless transceiver 118. Electrical or optical signals are sent via corresponding routes between the GPU dies 102, 104 and the optical transceiver 108. The signals 124, 126 enable the GPU dies 102, 104 to communicate with external networks via the optical transceiver 108, which may convert wireless signals received from the wireless transceivers 112, 114 into optical signals for fiber-based external communication. In some embodiments, the wireless transceivers 112, 114, 118 may operate in terahertz-range or millimeter-wave frequencies ranging from 20 GHz to 10 THz. At a frequency of 10 THz, the free-space wavelength is approximately 30 micrometers, and the antenna 910 may be implemented as an on-chip patch antenna, a dipole antenna, or a metamaterial-based radiator integrated into the redistribution layer (RDL) or the top metal layers of the transceiver die. In some embodiments, the antenna dimensions, on the order of tens of micrometers or smaller, are tuned to the specific sub-terahertz or terahertz carrier frequency (e.g., micron-scale for 10 THz operation) to minimize radiative loss within the package encapsulation. In some embodiments, planar antenna structures such as rectangular patches (with lateral dimensions of approximately 10 to 20 micrometers), circular patches (with a diameter in a similar range), or spiral configurations may be fabricated within the top metal layers of the transceiver die or within the RDL of the package. In some embodiments, the compact planar geometry of these structures can facilitate integration within the limited space of a co-packaged arrangement. In some embodiments, the antenna may be oriented to radiate in a direction parallel to the package substrate toward adjacent transceivers or the optical switch. In some embodiments, the physical spacing between antenna elements in an array configuration may be on the order of 15 to 30 micrometers to achieve desired radiation characteristics at 10 THz.

In some embodiments, the optical transceiver 108 is enabled to transmit data received in signals 124, 126 to other systems similar to the system 100. The optical transceiver 108 may interface with optical fibers for communication with external devices, including other processing devices, switches, or network interface cards. In some embodiments, the optical transceiver 108 may be configured to communicate with processing devices in other trays, server enclosures, or racks using the optical fiber interconnects.

In some embodiments, the system 100 may support dynamic channel remapping capabilities based on workload requirements. The mapping between lanes of the GPU dies 102, 104 and lanes of the wireless transceivers 112, 114 can be established through configuration settings that define which lanes are coupled together. IN some embodiments, these configuration settings represent configurable mappings, and may be dynamically adjusted or reconfigured based on system requirements, workload characteristics, operating conditions, or the like. In some embodiments, each wireless transceiver of the wireless transceivers 112, 114, 118 may maintain its own routing table defining its lane associations. Each routing table may specify which lanes of the associated GPU die are coupled to which lanes of the wireless transceiver. During remapping, the wireless transceivers may coordinate with each other to update their respective routing tables. For example, a first wireless transceiver initiating a remapping operation may transmit a coordination signal to a second wireless transceiver, and the second wireless transceiver may update its routing table in response to the coordination signal. The coordination between wireless transceivers may occur through the wireless communication fabric or through a separate control channel. In some embodiments, a hybrid approach may be used where a central controller maintains a global mapping table while each wireless transceiver maintains a local routing table that is updated based on instructions from the central controller. For example, when optical channel utilization decreases, the system 100 may dynamically reconfigure the wireless channels to reduce power consumption while maintaining sufficient bandwidth for the current workload. In some embodiments, reconfiguration may involve changing which lanes are associated with each other, adjusting the number of lanes used for communication, or redistributing data across different lane combinations. In some embodiments, the dynamic remapping may also be performed responsive to identifying a defective component, enabling the system to route communications around failed GPU dies or wireless transceivers.

The architecture of system 100 may enable all-to-all connectivity and improved GPU utilization. By providing additional degrees of freedom for establishing communication patterns, the wireless communication fabric may enable configurations that traditional wired interconnects may not support.

In some embodiments, the system 100 may be implemented within a tray, server enclosure, or across adjacent trays. The wireless transceivers 112, 114 may enable communication between GPU dies within the same tray or server enclosure using the terahertz-range wireless channels. Communication with processing devices in other trays or racks may utilize the optical fiber interconnects through the optical transceiver 108. In some embodiments, the wireless transceivers may also enable communication between processing devices on vertically-adjacent racks or within line-of-sight distances.

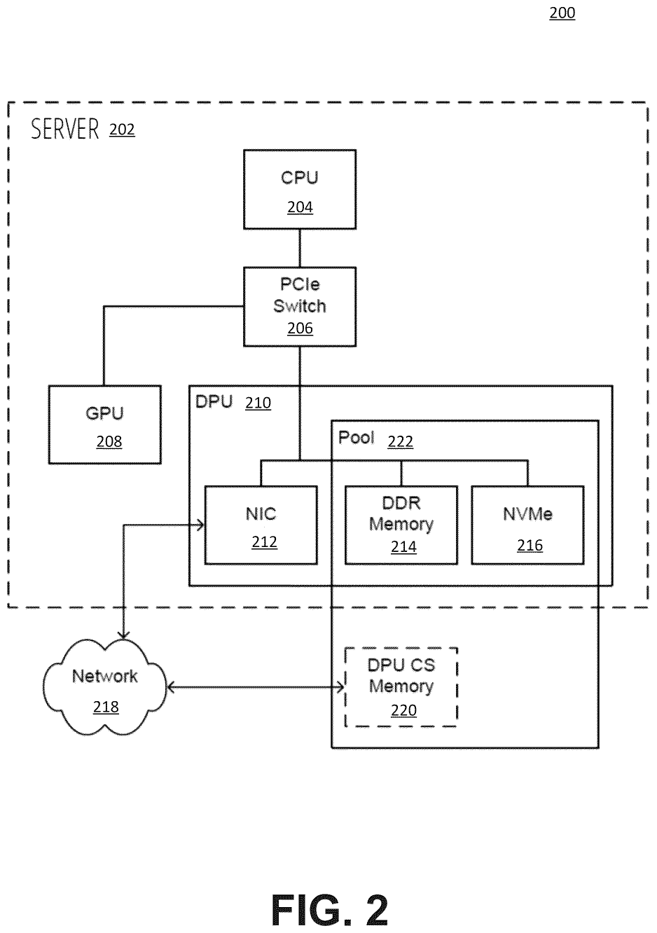

FIG. 2 illustrates an example computing environment 200, according to some aspects of the disclosure. In some embodiments, the example computing environment 200 may be used to perform forward pass offloading to available memory. The example computing environment 200 includes a server 202. In some embodiments, the server 202 is enabled to perform HPC workloads, such as AI training or machine learning model training. In some embodiments, the server 202 is an application instance or a compute node. The server 202 includes a CPU 204 associated with a switch 206, such as a peripheral component interconnect express (PCIe) switch, which can control at least some data transmission over communication paths interconnecting various components. In some embodiments, the CPU 204 includes a root complex processor.

In some embodiments, the PCIe switch 206 is also associated with a GPU 208 and a DPU 210, and can transmit data between at least some of the CPU 204, the GPU 208, the DPU 210, and other components. In some embodiments, the PCIe switch 206 is associated with more than one GPU or more than one DPU. In some embodiments, the PCIe switch 206 is located within the DPU 210. The PCIe switch 206 can manage the transfer of at least some data between the CPU 204, the GPU 208, and the DPU 210. In some embodiments, the number of GPUs associated with the PCIe switch 206 is equal to the number of DPUs associated with the PCIe switch 206. In some embodiments, the server 202 includes, without limitation, any number of the CPUs 204, the PCIe switches 206, the GPUs 208, and/or the DPUs 210, in any combination. For example, in some embodiments, server 202 could include eight, sixteen, thirty-two, and/or more GPUs 208. In some embodiments, one or more of the GPUs 208 may include multiple cores, which may communicate with one another and/or with CPUs 204, PCIe switches 206, DPUs 210, optical transceivers of the GPUs 208, and/or other components wirelessly.

In some embodiments, the switch 206 is an optical switch. In some embodiments, the switch 206 is implemented on a compute die, co-packaged with one or more transceiver dies arranged around the periphery of the switch die.

In some embodiments, various interconnected components include the CPU 204, the PCIe switch 206, the GPU 208, and the DPU 210. In some embodiments, communication paths that interconnect the various components can be implemented using any high-speed communication protocol, such as peripheral component interconnect (PCI) based protocols (e.g., PCIe), or other bus or point-to-point communication interfaces and/or protocol(s), such as Nvidia® Link (NVLink) high-speed interconnect, or interconnect protocols.

In some embodiments, the DPU 210 includes a network interface card (NIC) 212, a DDR memory 214, and a non-volatile memory express (NVMe) device 216. The NIC 212 can interface with a network 218, which can also interface with additional NVMe devices available to the DPU 210, such as over the wireless communication fabric. In some embodiments, the DPU 210 does not include the NVMe device 216. In some embodiments, the NVMe device 216 is located on the server 202 and not on the DPU 210.

In some embodiments, the NIC 212 and the DPU 210 can serve different roles in network architecture. For example, NIC 212 can primarily provide a hardware interface to connect elements of a computing system to a network. In some embodiments, the NIC 212 can handle basic network communication tasks such as formatting, sending, and receiving data packets. In some embodiments, the processing capabilities of the NIC 212 are limited to traditional network processing tasks.

The DPU 210 can be a specialized processing device designed to offload and accelerate complex data processing tasks, such as from the NIC 212 or attached computing system. In some embodiments, the NIC 212 combines a network interface, programmable processing, and storage capabilities and can perform tasks such as security, storage virtualization, and network telemetry.

In some embodiments, the computing environment 200 includes multiple NVMe device(s) 216, such as a first NVMe device in the DPU 210 and a second NVMe device on the server 202 associated directly with the PCIe switch 206. In some embodiments, the DPU 214 includes one or more of a computational storage services (CSS) and/or the DDR memory 214. For example, computing environment 200 includes DPU computational storage (CS) memory 220 available to the DPU 210 as part of the CSS.

In some embodiments, the network 218 interfaces with the memory 220 of the DPU 210 through the NIC 212. This communication interface can be implemented using any suitable interface protocol, such as remote direct memory access (RDMA) over Ethernet, InfiniBand, Fiber Channel, or the like. In some embodiments, the total memory of the computing environment 200 available for data storage can be expanded through the use of the DPU 210 on nodes of the system. The DPU 210 can have access to a pool 222 of memory already available to the server 202, such as double data rate (DDR) memory, on-board NVMe devices, NVMe devices over fabric, and CS. The pool 222 of memory includes at least one of the DDR memory 214, NVMe device 216, and the DPU CS memory 220.

In some embodiments, each DPU, such as DPU 210 can access the available memory of other respective DPUs as part of the pool 222. This available memory can be accessed and used for data storage, without the addition of compute resources, such as compute nodes, which would be required using other solutions.

In some embodiments, the available pool 222 accessible to the DPU 210 is provisioned for the server 202 to expand the total memory available for data storage, such as to reduce the data storage load on the CPU 204 or the GPU 208, which can increase the use of their memory for processing. For example, during training of an AI, the model states, residual states, activation functions, and checkpoints can be stored, or offloaded, on the pool 222 accessible to the DPU 210.

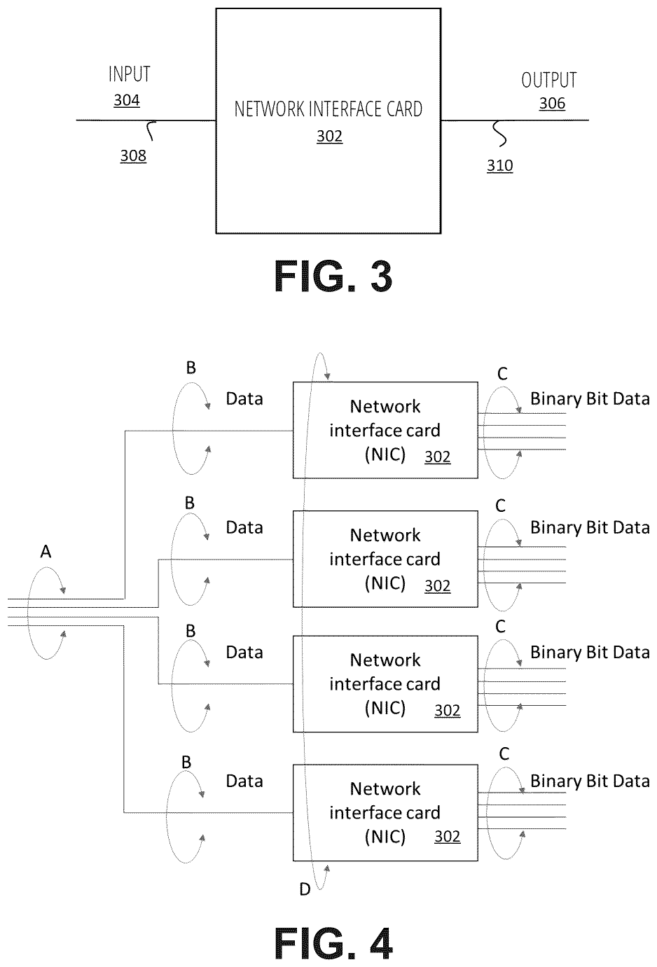

FIG. 3 illustrates a network interface card 302 that includes a hardware component (e.g., a network interface controller) configured to connect to a network and/or to facilitate communications within the network. In some embodiments, the network interface card 302 is included in and/or is coupled to a network interface module such as a transceiver device (e.g., an optical transceiver) that facilitates fiber optic communication. In some embodiments, the network interface card 302 is configured to manage transmission of one or more optical signals via one or more optical fibers. In some embodiments, the network interface card 302 is configured to control emission of one or more optical signals via one or more lasers.

In some embodiments, the network interface card 302 includes an input 304 and an output 306 coupled to a communication channel 308 and a communication channel 310. In some embodiments, to satisfy high bandwidth requirements, the network interface card 302 can include an optical switch (such as switch 106) implemented on a compute die that is co-packaged with one or more transceiver die(s) arranged around the periphery of the switch die. A network interface card 302 such as the one illustrated can use a co-packaged die arrangement in accordance with the embodiments described herein.

In some embodiments, the communication channel 308 can include an optical communication channel (e.g., a transparent fiber optical connection) that transmits data (e.g., pulses of infrared light) encoded as bits (e.g., a binary data stream). In some embodiments, the network interface card 302 is configured to output bits via the communication channel 310. In some embodiments, the communication channel 308 and/or the communication channel 310 are bi-directional.

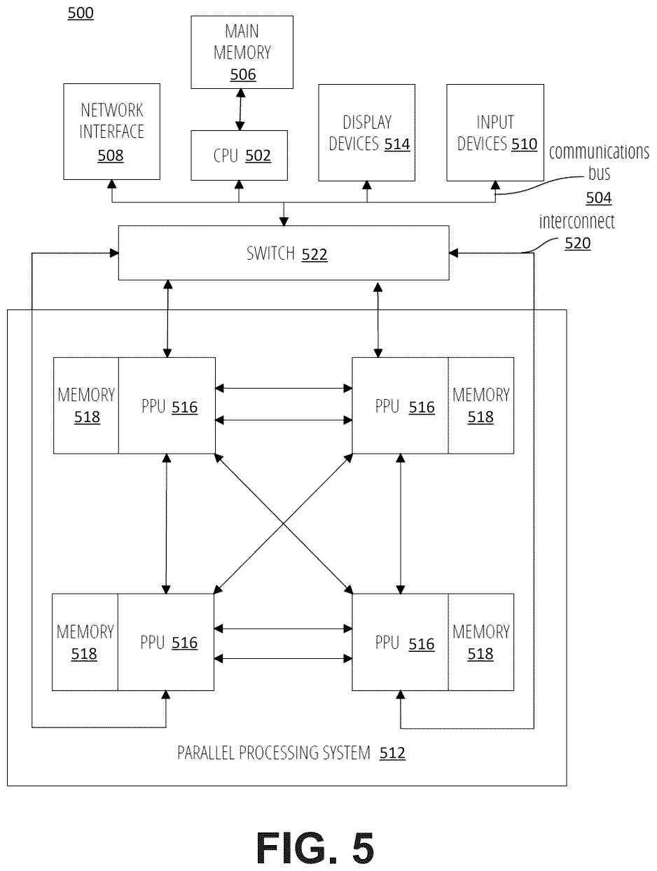

FIG. 4 illustrates an example of a system including multiple network interface cards, according to aspect of the disclosure. Each of the network interface cards 302 can be configured in one of the manners described above. In some embodiments, inputs such as signal(s) A and signal(s) B (which are data signals) are input to a number D of network interface cards 302 and routed out of the network interface cards 302 as signal(s) C (which may comprise binary bit data). In some embodiments, signals A, B, and C are one or more of optical (photonic), electronic, and/or a mixture of optical and electronic.

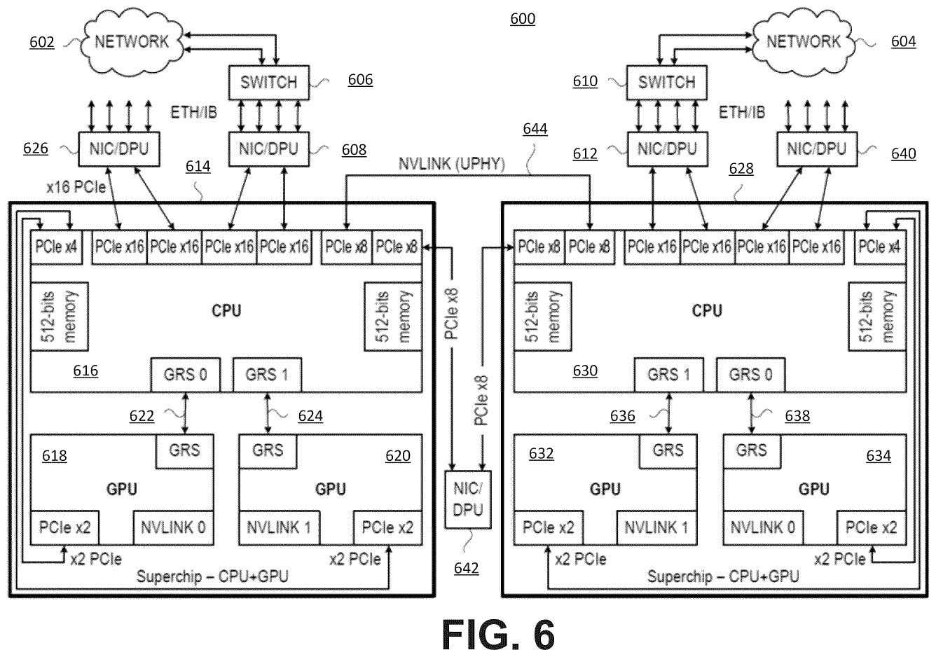

FIG. 5 illustrates a computer system 500, according to some aspects of the disclosure. In some embodiments, computer system 500 is configured to implement various processes and methods described throughout this disclosure.

In some embodiments, computer system 500 includes, without limitation, at least one central processing unit (“CPU”) 502 that is connected to a communication communications bus 504 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In some embodiments, computer system 500 includes, without limitation, a main memory 506 and control logic (e.g., implemented as hardware, software, or a combination thereof) and data are stored in main memory 506 which can take form of random access memory (“RAM”). In some embodiments, control logic can include, for example, one or more of a processor, a microcontroller, a field programmable gate array (FPGA), and/or state machine circuitry. In some embodiments, a network interface subsystem (“network interface”) 508 provides an interface to other computing devices and networks for receiving data from and transmitting data to other systems from computer system 500.

In some embodiments, the computer system 500 includes, without limitation, input devices 510, parallel processing system 512, and display devices 514. In some embodiments, display devices 514 can include one or more of a cathode ray tube (“CRT”), liquid crystal display (“LCD”), light emitting diode (“LED”), plasma display, or other suitable display technologies. In some embodiments, user input is received from input devices 510. In some embodiments, input devices 510 include one or more of a keyboard, mouse, touchpad, microphone, and the like. In some embodiments, each of foregoing modules is situated on a single semiconductor platform to form a processing system.

In some embodiments, computer programs in form of machine-readable executable code or computer control logic algorithms are stored in main memory 506 and/or secondary storage. Computer programs, if executed by one or more processors, enable computer system 500 to perform various functions according to some aspects of the disclosure. Main memory 506, secondary storage, and/or any other storage are possible examples of computer-readable media. In some embodiments, secondary storage can refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In some embodiments, architecture and/or functionality of various previous figures are implemented in context of CPU 502; parallel processing system 512; an integrated circuit capable of at least a portion of capabilities of both CPU 502; parallel processing system 512; a chipset (e.g., a group of integrated circuits designed to work and sold as a unit for performing related functions, etc.); and any suitable combination of integrated circuit(s).

In some embodiments, architecture and/or functionality of various previous figures are implemented in context of a general computer system, a circuit board system, a game console system dedicated for entertainment purposes, an application-specific system, and more. In some embodiments, computer system 500 can take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In some embodiments, parallel processing system 512 includes, without limitation, one or more of parallel processing units (“PPUs”) 516 and associated memories 518. In some embodiments, PPUs 516 are connected to a host processor or other peripheral devices via an interconnect 520 and a switch 522 or multiplexer.

In some embodiments, the switch 522 is an optical switch implemented on a compute die, co-packaged with one or more of wireless chiplets arranged around the periphery of the switch die. A switch 522 such as the one illustrated can use a co-packaged die arrangement in accordance with the embodiments described herein.

In some embodiments, parallel processing system 512 distributes computational tasks across PPUs 516 which is parallelizable-for example, as part of distribution of computational tasks across multiple graphics processing unit (“GPU”) thread blocks. In some embodiments, memory is shared and accessible (e.g., for read and/or write access) across some or all of PPUs 516, although such shared memory can incur performance penalties relative to use of local memory and registers resident to a PPU 516. In some embodiments, operation of PPUs 516 is synchronized through use of a command such as_syncthreads ( ), wherein all threads in a block (e.g., executed across multiple PPUs 516 to reach a certain point of execution of code before proceeding.

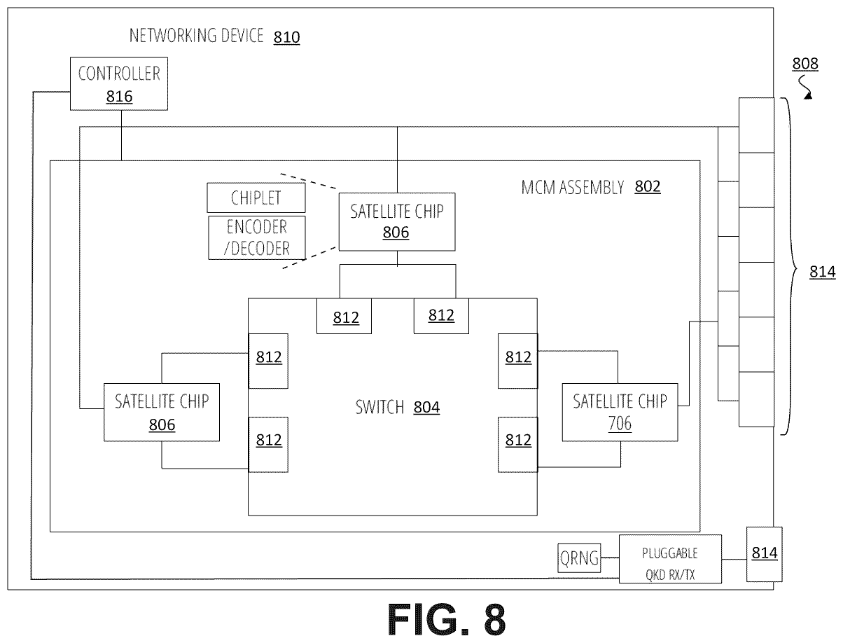

The layout flexibility enabled by the wireless channels (as described below with reference to FIG. 7) can further enable configurations that are not achievable with traditional wired interconnects. For example, the floating transceivers (also referred to as wireless chiplets) can be arranged such that individual dies (e.g., individual wireless chiplets) within a multi-die processing device participate in different communication domains independently. This flexibility can improve workload distribution and enable better use of processing resources.

In some embodiments, the wireless communication fabric described herein can enable communication between processing devices within the same tray or server enclosure using the terahertz-range wireless channels. Moreover, wireless communication between individual dies, cores, chiplets, and/or other components within a package may be achieved using the terahertz-range wireless channels. In some embodiments, processing devices that communicate wirelessly within the same enclosure can use low-power chip-to-chip or tray-level wireless transceivers, while communication with processing devices in other trays or racks can use the optical fiber interconnects described herein.

In some embodiments, the layout flexibility and port scalability enabled by the wireless channels (as described above) can be implemented for high-performance and/or AI workloads where all-to-all connectivity between processing devices and/or portions thereof (e.g., groups of compute dies and/or chiplets) as described in embodiments herein is beneficial. As described herein, the wireless communication fabric can provide additional degrees of freedom for establishing communication patterns that traditional wired interconnects can not support.

In some embodiments, the wireless communication fabric can also enable use of processing devices that would otherwise be underused in traditional wired configurations. For example, the wireless chiplets described herein can enable processing devices to participate in communication domains regardless of power-of-two constraints that can apply to traditional wired interconnects. This capability can improve overall system use.

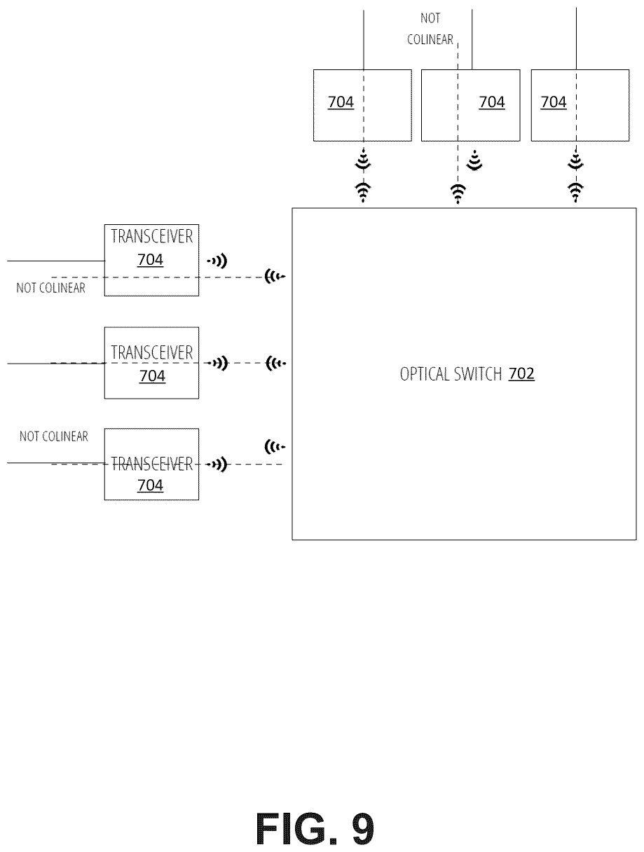

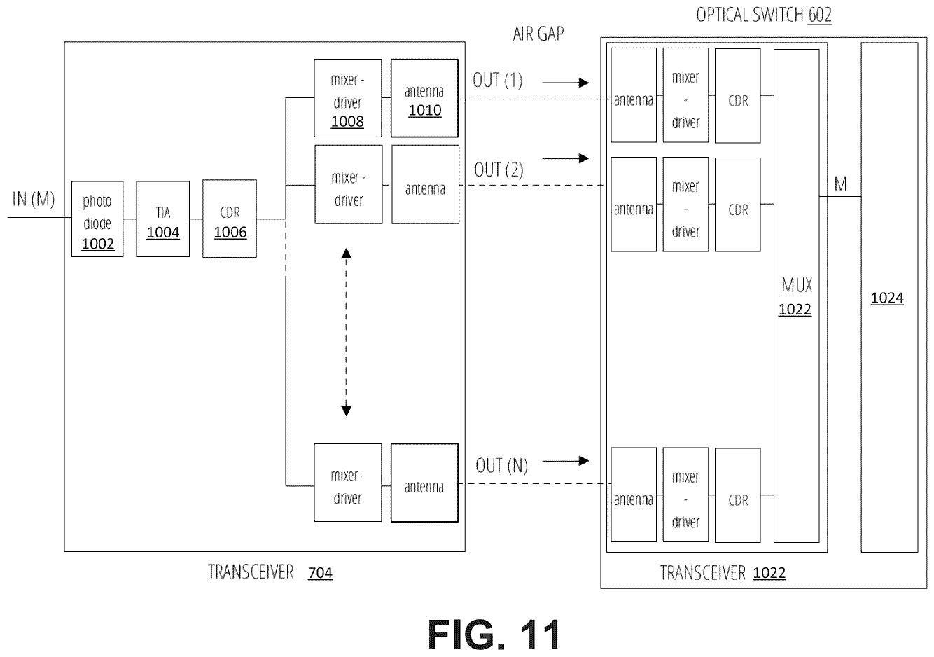

The chiplets described herein (with reference to FIG. 7 and FIG. 8) include chiplets, where a chiplet refers to a smaller die that is combined with other chiplets to form a complete processing device. In some embodiments, the wireless communication fabric can enable communication between chiplets, with each chiplet potentially including an integrated wireless transceiver or being coupled to a dedicated wireless transceiver as further described with reference to FIG. 10, below.

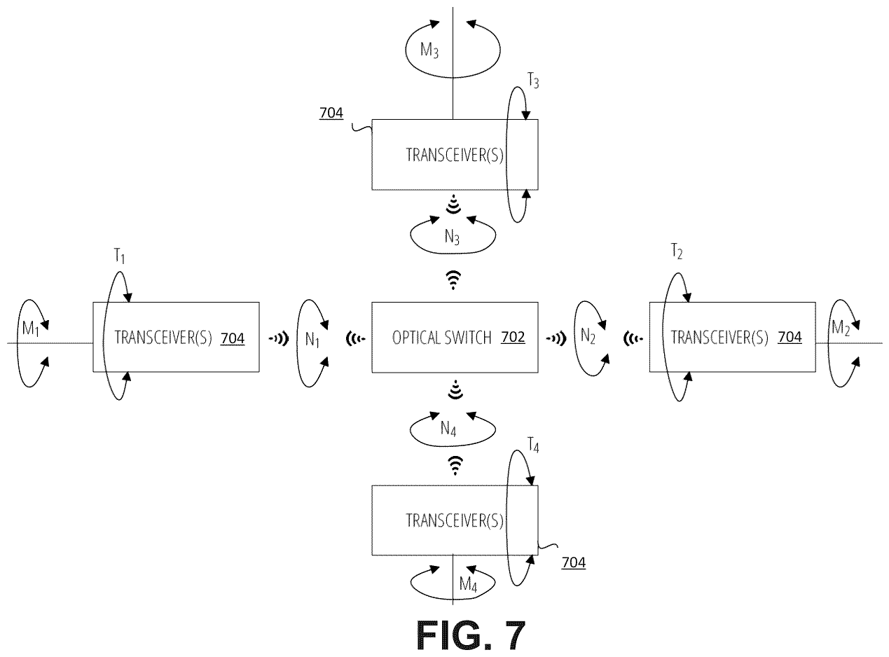

FIG. 6 illustrates a block diagram that schematically illustrates a computing system 600, e.g., a data center or a High-Performance Computing (HPC) cluster, in accordance with an embodiment that is described herein. The computing system 600 includes one or more of subsystems, e.g. multiple processing devices coupled to each other, multiple network devices, and multiple networks, according to some aspects of the disclosure. Computing system 600 is designed with multiple integrated circuits (referred to as processing devices), where each integrated circuit includes one or more CPUs and GPUs, forming a powerful and flexible architecture.

In some embodiments, the various processing devices can be interconnected via high-speed interconnect, enabling high-speed communication between the subsystems, and are also connected through a NIC (e.g., NIC 112) or DPU (e.g., DPU 110) to ensure efficient data transfer across computing system 600 and to one or more external networks 602, 604. In some embodiments, the NIC and DPU can be coupled and/or packaged together, such as NIC/DPU 608, 612. As illustrated, system 600 includes a packet switch 606 that connects NIC/DPU 608 to network 602, and a packet switch 610 that connects NIC/DPU 612 to network 604. In some embodiments, one or more of the NICs, DPUs, and switches illustrated can use a co-packaged die arrangement as described herein.

In some embodiments, the coupling of processing devices through high-speed interconnects allows for seamless data exchange and parallel processing, enhancing overall computational performance. In some embodiments, the processing devices are connected to multiple networks through one or more NICs or DPUs, enabling the system to handle complex, multi-network tasks with high-bandwidth and low latency. In some embodiments, this configuration is highly suitable for demanding applications that require significant processing power, such as artificial intelligence (AI), machine learning (ML), and data-intensive computing, while ensuring robust connectivity and scalability across various networked environments. The integrated circuits of the computing system 600 includes one or more CPUs and one or more GPUs.

As illustrated, computing system 600 includes a processing device 614 with a multi-GPU architecture. In some embodiments, processing device 614 is a system-on-chip that includes multiple subsystems such as a CPU 616, a GPU 618, and a GPU 620. In some embodiments, CPU 616 is coupled to GPU 618 via a die-to-die (D2D) or chip-to-chip (C2C) interconnect 622, such as a Ground-Referenced Signaling interconnect (GRS interconnect). In some embodiments CPU 616 is coupled to GPU 620 via a D2D or C2C interconnect 624. In some embodiments, CPU 616 can also couple to GPU 618 and GPU 620 via PCIe interconnects.

In some embodiments, CPU 616 is coupled to one or more NICs or DPUs, which are coupled to one or more networks. For example, as illustrated in FIG. 6, CPU 616 is coupled to a first NIC/DPU 626, which is coupled to a network 602. In some embodiments, CPU 616 is also coupled to a second NIC/DPU 608, which is coupled to network 602 via switch 606. In some embodiments, NIC/DPU 626 and NIC/DPU 608 are coupled to network 602 over Ethernet (ETH), NVLINK or InfiniBand (IB) connections, for example.

Computing system 600 includes a processing device 628 with a multi-GPU architecture. In some embodiments, processing device 628 includes multiple subsystems including a CPU 630, a GPU 632, and a GPU 634. CPU 630 is coupled to GPU 632 via an D2D or C2C interconnect 636. CPU 630 is coupled to GPU 634 via a D2D or C2C interconnect 638. CPU 630 can also couple to GPU 632 and GPU 634 via PCIe interconnects. CPU 630 is coupled to one or more NICs or DPUs, which are coupled to one or more networks. For example, as illustrated in FIG. 6, CPU 630 is coupled to a first NIC/DPU 612, which is coupled to a network 604. CPU 630 is also coupled to a second NIC/DPU 640, which is coupled to network 604 via switch 610. NIC/DPU 612 and NIC/DPU 640 is coupled to network 604 over Ethernet (ETH), NVLINK or InfiniBand (IB) connections.

In some embodiments, processing device 614 and processing device 628 can communicate with each other via a NIC/DPU 642, such as over PCIe interconnects. In some embodiments, processing device 614 and processing device 628 can also communicate with each other over a high-bandwidth communication interconnects 644, such as an NVLink interconnect or other highspeed interconnects. In some embodiments, the packet switches can include, for example, Nvidia Quantum-2 switches. In some embodiments, the NIC/DPUs 612, 626, 640, 642 can include, for example, Nvidia Bluefield DPUs.

Referring to FIG. 7, in embodiments a compute die of a package includes an optical switch 702 (e.g., a compute die including the optical switch 702) with a number of floating transceivers (e.g., which may be or include wireless chiplets) 704 disposed around its periphery. In general, one or all of the transceivers 704 can each be implemented using N>=1 physical die. The figure shows the connection of the transceiver with the optical switch for a single channel. The transceivers 704 may be spatially arranged along multiple sides of the optical switch 702, with the number and spacing of transceivers on each side determined by bandwidth requirements and/or physical constraints. The floating nature of the transceiver(s) 704 (e.g., transceiver die) can facilitate replacement of individual transceivers without disturbing adjacent components, and can simplify alignment during manufacturing since precise fiber-based connections to the compute die are not required.

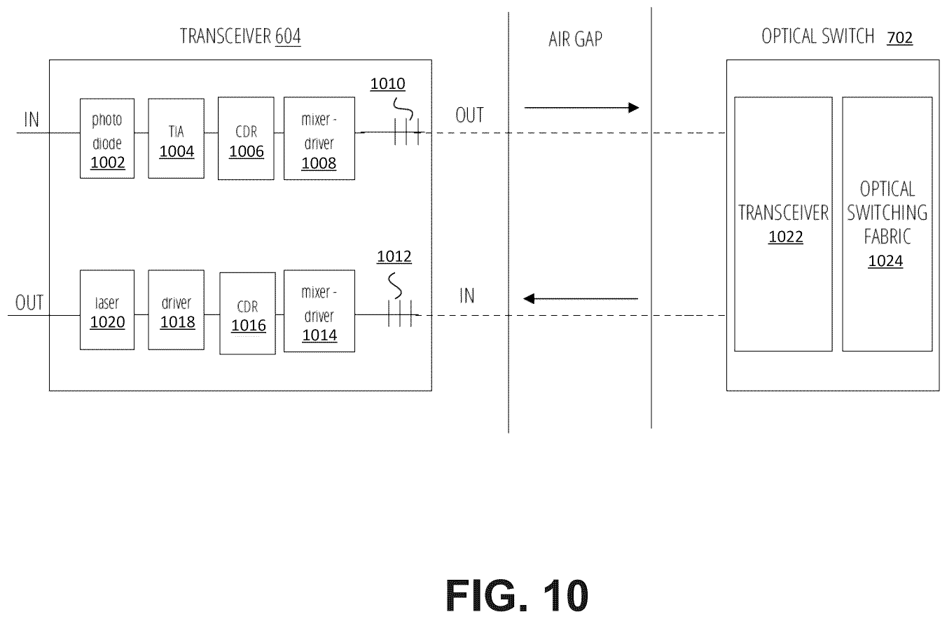

Each transceiver 704 may comprise an arrangement of elements that transform light signals to and from wireless signals, as is further described below with reference to FIG. 9. The transceiver chain includes several building blocks enabling the transition from an optical channel (i.e. on light via a fiber-based channel) to a wireless channel (i.e. on air): no fiber connections between the compute die (e.g., main tile) and the adjacent optical chiplets (e.g., optical tiles). The package may for example be implemented as a multi-die integrated circuit that interfaces to a Network Interface Card (NIC) or Data Processing Unit (DPU), and/or in a NIC or DPU itself. In some embodiments, wireless channel paths between each transceiver 704 and the optical switch 702 are configured to provide line-of-sight communication, with the package layout accommodating direct propagation paths. In some embodiments, optical fibers from each transceiver 704 are routed to external connections at the package periphery or front panel.

In some embodiments, modern processing devices can be implemented as chiplet architectures where multiple smaller dies (chiplets) are combined to form a complete processor. Each chiplet is a standalone functional unit capable of independent operation, distinguishing chiplet architectures from monolithic dies that are merely divided for manufacturing purposes. Chiplet architectures can enable fine-grained wireless connectivity where individual chiplets communicate independently with different destinations.

In some embodiments, chiplets can be communicatively coupled using an interconnect mechanism (e.g., embedded multi-die interconnect bridge (EMIB)). Non-limiting examples of chiplets or tiles that may be co-packaged include memory chiplets/tiles (e.g., High Bandwidth Memory-HMB), substrate chiplets/tiles, base chiplets/tiles, link chiplets/tiles, and EMIB chiplets/tiles. In some embodiments, a co-packaging arrangement includes a compute chiplet/tile with a number (e.g., 8) of graphics cores, an L1 cache, a base chiplet/tile with a PCI (e.g., PCIe 5) host interface, memory chiplets/tiles (e.g., HBM2e), a Multiple Data Flow Interface chiplet/tile (MDFI), an EMIB chiplet/tile, and a link chiplet/tile including multiple links and ports (e.g., 8 links and 8 ports with an embedded switch).

In some embodiments, the chiplets/tiles of the package are connected use face-to-face (F2F) chip-on-chip bonding through fine-pitched micro-bumps (e.g., copper pillars). In some embodiments, the package includes a graphics core that includes a memory fabric and memory chiplets/tiles communicatively coupled to multiple other chiplets/tiles. In some embodiments, the graphics core in such embodiments can store, access, and/or load hardware contexts in the memory, where a hardware context is a set of data loaded from registers, and where a hardware context can define a state of the components in the package (e.g., the state of a graphics processing unit).

In some embodiments, each chiplet or tile includes an integrated wireless transceiver or is coupled to a dedicated wireless transceiver. In some embodiments, a processing device including four chiplets may be configured such that one chiplet communicates with four external processing devices, while another chiplet communicates with three different external processing devices. In some embodiments, such a configuration may be adjusted on-the-fly such that the external processing devices that one or more chiplets communicates with are adjusted as a workload changes. Additionally, chiplets may wirelessly communicate with other chiplets within the same processing device (e.g., GPU) and/or within other processing devices (e.g., other GPUs, DPUs, CPUs, etc.). In some embodiments, this enables workload-specific communication topologies where different portions of a processing device participate in different communication patterns simultaneously. In some embodiments, the workload-specific communication topologies can be changed dynamically as the workload changes.

The optical switch 702 includes an optical switching fabric configured to ingest data packets at various source/input lanes or ports and route the packets to various output/destination lanes or ports. In some embodiments, the optical switch 702 includes internal components operating at different speeds. Each of the input lanes or ports and output lanes or ports of the optical switch 702 includes N≥1 wireless communication channels. In some embodiments, the wireless communication channels can for example be terahertz or millimeter wave, operating at bandwidths ranging from 20 GHz to 10 terahertz.

In some embodiments, a number Tₓ of wireless chiplets (e.g.., transceiver die) are disposed along a given side of the optical switch 702, where Tₓ can vary by side. Each of the wireless chiplets (e.g., transceiver die) may be configured to communicate with the optical switch 702 over the Nₓ wireless channels, where Nₓ may be configurable for each transceiver 704 or for some subset of the transceivers 704. In some embodiments, each transceiver 704 may be configured with a number Mₓ≥1 optical fiber-based input channels and Mₓ fiber-based output channels, where again Mₓ may be configurable for each transceiver 704. In some embodiments, the Mₓ optical channels may be supplied to a given transceiver 704 be a single fiber or multiple fibers. In embodiments where Mₓ≠Nₓ, one or more of the transceivers 704 can operate as channel multiplexers, demultiplexers, or combinations thereof.

In some embodiments, optical switches (e.g., switch 206 of FIG. 2) are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches is used in common data center interconnection topologies, e.g., fat trees, Slim Fly, and Dragonfly+). In addition, inventive concepts propose to place such hybrid switching systems “in the middle” of the network (e.g., replacing the edge/top of rack (TOR) layer and aggregation layer).

In some embodiments, an optical switch can include hardware and/or software for routing signals in the optical domain. In some embodiments, an optical switch includes input optical fibers and output optical fibers that carry optical signals as well as one or more devices suited for routing optical signals within the optical switch. For example, the one or more devices for routing optical signals includes one or more movable mirrors (e.g., MEMS mirrors) that are controlled to move in a manner that directs light from an input fiber to a desired output fiber or to move in a manner that forces or guides light from one waveguide into another waveguide. An optical switch includes one or more devices for amplifying light in order to compensate for propagation and scattering losses introduced by the optical switch. In at least one example embodiment, signals input and output to an Application Specific Integrated Circuit (ASIC) are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch includes electrical to optical to electrical conversion hardware and/or software if desired (e.g., if the input signal and/or output signal is an electrical signal).

In some embodiments, the optical switch(es) include an arrayed waveguide grating router (AWGR), which is a passive switch fabric. In some embodiments, the optical switch(es) can correspond to a passive element that operates as a wavelength router that uses multiple wavelengths to interconnect outputs and inputs by following a specific cyclic wavelength routing pattern.

In some embodiments, an optical switch can directly route optical signals without converting them to electrical signals. Each optical switch includes optical receivers, such as photodetectors and wavelength-division multiplexing (WDM) demultiplexers, that receive incoming optical signals. In some embodiments, these optical signals can then be directed through internal optical switching components, such as micro-electromechanical systems (MEMS) mirrors, waveguides, or optical cross-connects, which route the signals to the appropriate output paths. In some embodiments, the optical switch can also include optical transmitters, such as laser diodes and modulators, which transmit the routed optical signals to the next switch in the network. In some embodiments, a hybrid electro-optical switch can combine both electrical and optical components to route signals. Such a switch includes receivers that convert optical signals into electrical signals using TIAs and photodetectors, similar to those in electrical switches. These electrical signals can then be routed within the switch using internal electrical switching circuitry. Additionally, the hybrid switch can contain optical switching components, such as WDM multiplexers and MEMS devices, to route optical signals directly. In some embodiments, the transmitters in a hybrid switch includes both electrical-to-optical converters and direct optical transmitters, enabling the hybrid switch to interface with both electrical and optical networks. For example, a hybrid switch's transmitter includes a light source, a modulator for optical signals, and traditional electrical signal transmitters, providing routing capabilities across different signal domains.

In some embodiments, the interconnections between the switches within the network topology is implemented via optical fibers or traditional electrical cables, depending on the specific requirements of the system. For example, the communication lanes can be constructed of dedicated differential cable pairs and/or fiber optics, each tailored to provide optimal performance for the data transmission needs. In some embodiments, the dedicated differential cable pairs used in these interconnections includes a variety of cable media such as copper, aluminum, gold, silver, nickel, or composite materials like copper-clad aluminum, copper-clad steel, or bimetallic conductors. These materials are chosen for their electrical conductivity and durability, ensuring reliable and efficient data transmission. For example, in a four-lane network, each lane can consist of its own dedicated copper cable, providing isolated physical paths for each communication lane of a deserialized data stream. This configuration helps in maintaining signal integrity and reducing crosstalk between lanes.

In some embodiments, fiber optic cables is employed for the interconnections. Fiber optics are capable of transmitting data streams via different wavelengths of light, with each data stream assigned a unique wavelength. The use of fiber optic cables can allow multiple data streams to be transmitted simultaneously through a single fiber optic cable, significantly increasing the bandwidth and efficiency of the network, and particularly advantageous for long distance data transmission and for applications requiring high data transfer rates.

In some embodiments, various optical networking technologies are used to transmit multiple optical signals (e.g., data signals or data streams) over a single optical fiber within an optical link with little to no optical signal interference. These technologies can be used to improve bandwidth efficiency and reduce the amount of infrastructure needed for data communication.

For example, and in some embodiments, the optical networking technology is Time Division Multiplexing (TDM). In TDM, multiple optical signals can be transmitted over a single optical fiber by assigning each optical signal a respective time slot and transmitting an optical signal during its assigned time slot. The time slots are allocated in a cyclic manner, with each optical signal transmitting a small amount of data during its assigned time slot. The time slots are very short, on the order of microseconds, and the cycle repeats many times per second, allowing for rapid data transfer.

For example, and in some embodiments, the optical networking technology is Frequency Division Multiplexing (FDM). In FDM, multiple optical signals are transmitted over a single optical fiber by assigning each optical signal a respective frequency band. Each optical signal is modulated onto a respective carrier frequency to generate a modulated signal, and these modulated signals are combined and transmitted over a single optical fiber. At the receiver, the modulated signals are separated using filters (e.g., band-pass filters) that permit optical signals meeting specific frequency specifications to pass through while filtering out other signals. FDM allows optical links to simultaneously transmit multiple channels over the same frequency band.

For example, and in some embodiments, the optical networking technology is Wavelength Division Multiplexing (WDM). In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber.

Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

In some embodiments, a switch includes input circuits and output circuits, linked by switching core. In some embodiments, the switch is implemented in a network, most specifically in a switching fabric, such as an InfiniBand fabric. In some embodiments, the switch includes multiple inputs and outputs.

A number of architectures of this type include “Next Generation I/O” (NGIO) and “Future I/O” (FIO), culminating in the “InfiniBand” architecture, which has been advanced by a consortium led by a group of industry leaders (including Intel, Sun, Hewlett Packard, IBM, Compaq, Dell and Microsoft). Storage Area Networks (SAN) provide a similar, packetized, serial approach to high-speed storage access, which can also be implemented using an InfiniBand fabric.

Communications between a parallel bus and a packet network generally require a communications interface, to convert bus cycles into appropriate packets and vice versa. For example, a host channel adapter or target channel adapter is used to link a parallel bus, such as the PCI bus, to the InfiniBand fabric. When the adapter receives data from a device on the PCI bus, it inserts the data in the payload of an InfiniBand packet, and then adds an appropriate header and error checking code, such as a cyclic redundancy check (CRC) code, as required for network transmission. The InfiniBand packet header includes a routing header and a transport header. The routing header contains information at the data link protocol level, including fields required for routing the packet within and between fabric subnets. The transport header contains higher-level, end-to-end transport protocol information. Similar headers are used in other types of packet networks known in the art, such as Internet Protocol (IP) networks.

In some embodiments, a computer system is used in other devices such as handheld devices and embedded applications. Some examples of handheld devices include cellular phones, Internet Protocol devices, digital cameras, personal digital assistants (“PDAs”), and handheld PCs. In some embodiments, embedded applications includes a microcontroller, a digital signal processor (DSP), an SoC, network computers (“NetPCs”), settop boxes, network hubs, wide area network (“WAN”) switches, or any other system that can perform one or more instructions. In some embodiments, computer system is used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 264 Ports InfiniBand NDR Switch). In some embodiments, optical cables and connectors are designed to comply with any applicable standard, for example Ethernet and InfiniBand standards, such as Ethernet variants 200GBASE-FR4, 400GBASE-FR4, and 100 GBASE-LR4 to support four wavelengths. High-capacity optical switch assemblies switch multiple channels of data at high data rates, with the number of channels reaching several hundreds and data rates reaching hundreds of Gb/s (Gb/s=109 bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers.

Space constraints of the switch and the front panel limit the number of optical fibers connected to the ASIC and optical receptacles on the panel. Therefore, the optical signals emitted and received by the switch are multiplexed using wavelength-division multiplexing, so that each fiber, along with the associated optical receptacle, carries multiple optical signals. For example, each fiber can carry four channels of 100 Gb/s each, at four different, respective wavelengths, to and from the corresponding optical receptacle, for a total data rate of 400 Gb/s (denoted as 4×100).

In many cases, the multiple communication channels carried at different wavelengths on the same fiber are directed to and from different network nodes. For example, each of the 100 Gb/s component signals on a 4×100 optical link can be directed to a different server. Therefore, there is a need for an optical cable that is capable of splitting the multiplexed optical signal into multiple component signals at different, respective wavelengths, and be capable of conveying each of these signals to a different network node. For simplicity of installation and use, it is desirable that the optical cable be “active,” meaning that transceivers in the cable convert each of the multiple optical signals to a standard electrical form (and vice versa). As a result, the network nodes need process only electrical signals and will be indifferent to the actual wavelength of the optical channel that is directed to each of them.

To further simplify installation and use, it is sometimes desirable that the optical cable be detachable from the transceivers so that a smaller cable can be routed through an installation. Each optical cable can, instead of including a transceiver, be designed to mate with a particular transceiver. The transceiver can be connected to a node, such as a server, and be used to connect a connector of each cable to the node as described herein.

FIG. 8 illustrates a co-packaged system according to some aspects of the disclosure. A co-packaged optics package can integrate photonic high-speed optical interconnect components with functional switch application-specific integrated circuits (ASICs) or graphics processing units (GPUs) on a common substrate. By using co-packaged optics packages, computing systems can significantly reduce cost and power consumption over current systems. Current methods of manufacturing co-packaged optics packages involve optical elements that require active alignment in order to transmit the optical signal properly. In a traditional co-packaged optics package, an optical signal is transmitted via optical fibers to a connector that is either fixed (e.g., connected by adhesive) or detachable (e.g., connected by a clip) to a SiP die. Copackaging may refer to the close integration of different electrical and/or optoelectronic chips in the same package. In some embodiments, the different chips that constitute the co-packaged system may be assembled on a single substrate in what is typically called a multi-chip module (MCM) assembly 802. The multi-chip module assembly 802 may include switch 804 surrounded by peripheral chips, which may also be referred to as satellite chips 806 or chiplets. In some embodiments, the switch 804 and satellite chips 806 may all be mounted on a common substrate, although such a configuration may not be required. The various components of the multi-chip module assembly 802 may be coordinated and controlled by way of a central controller 816.

In some embodiments, the multi-chip module assembly 802 is disposed proximate to a front panel 808 of a housing of a networking device 810 (e.g., the network device(s) of a data center). In some embodiments, the switch 804 includes one or more core digital Application Specific Integrated Circuits (ASICs), CPUs, GPUs, microprocessors, FPGAs, combinations thereof, and the like.

In some embodiments, the switch 804 includes a number of input lanes or ports and/or output lanes or ports 812. The Input/Output (I/O) lanes or ports 812 may include electrical lanes/ports and/or optical lanes/ports. The switch 804 may include a combination of electrical blocks and optical blocks. In some embodiments, the electrical blocks of the switch 804 includes a number of electrical switches that are configured to route signals in an electrical domain. In some embodiments, the optical blocks of the switch 804 includes a number of optical components that are configured to generate, detect and route signals in an optical domain. In some embodiments, a configuration of the optical block(s) and a configuration of the electrical block(s) depends (e.g., is based on) on the number of optical lanes in the I/O lanes 812.

In some embodiments, optical connectors 814 is disposed proximate to the front panel 808. In some embodiments, connectivity between the multi-chip module assembly 802 and optical connectors 814 is implemented using optical fibers. This connection may be made directly with an optical I/O lane/port 812 of the switch 804 or may be made with one or more of the peripheral chiplets 806 (also referred to as satellite chips). The connection may be made with one or more of the peripheral chiplets 806 because the peripheral chiplets 806 may include electro-optic converters and, possibly, a serializer/deserializer to natively support the connection. In some embodiments, the peripheral chiplets 806 include one or more of a DSP processor, driver, trans-impedance amplifier, laser, modulator, photodiode, serializer-deserializer, or the like.

In the context of high-throughput switches and optoelectronics, co-packaged arrangements can enable relocation of optoelectronic transceivers from the front panel 808, where they are deployed in the form of pluggable modules, to the peripheral chiplets 806 of the networking devices 810. In some embodiments, the fiber optical I/Os from the peripheral chiplets 806 is disposed at the front panel 808, replacing the bulky pluggable ports. In some embodiments, this saves area proximate to the front panel 808 which can be used to accommodate integration of one or more other systems.

In some embodiments, the switch 804 and peripheral chiplets 806 are co-packaged into an optical-electrical circuit and implemented as an application specific integrated circuit (ASIC) configured to generate data signals and one or more of symbol encoding circuits configured to convert the data signals to symbols, the symbol encoding circuits arranged as peripheral chiplet 806 around the compute die including the switch 804, and a terahertz spectrum multiband wireless signaling interface coupling the symbol encoding circuits to the compute die.

FIG. 9 illustrates an exemplary co-packaged arrangement, according to some aspects of the disclosure. The co-packaged arrangement includes a compute die containing the switch, wireless chiplets (e.g., floating optical tiles) containing the optical transceivers, high-speed interconnects between the compute die (e.g., central switch tile) and the wireless chiplets (e.g., floating optical tiles) and external high-speed interconnects connecting the wireless chiplets with the rest of the network. A challenge in the switch co-packaged arrangement is how to implement effectively the high-speed interconnect between the compute die and the wireless chiplets.

In some embodiments, a non-colinear arrangement, where an optical fiber input to a transceiver 704 is not aligned with a wireless channel to the optical switch 702, facilitates flexible circuit layout. This configuration allows optical fibers to follow grid lines or other routing paths while wireless channels maintain direct line-of-sight paths, reducing manufacturing complexity by decoupling fiber routing from wireless alignment requirements. For example, where the co-packaged arrangement includes a central tile comprising the optical switch 702 and a plurality of optical tiles comprising transceivers 704, wireless interconnects may be used between the central tile and the floating tiles and/or fiber optic interconnects coupling the floating tiles with a wider network.

FIG. 10 illustrates additional aspects of a coupling between a transceiver 704 and an optical switch 702, according to some aspects of the disclosure. In some embodiments the transceiver 704 includes components enabling a transition from an M-channel optical fiber lane or port to the N-channel wireless interface to the optical switch 702. The transceiver 704 may be fabricated, for example with CMOS components, BiCMOS components, SOI components, or any other suitable technology.

In some embodiments, the conversion path between a fiber input lane or port and the wireless channels may comprise a photodiode 1002, a transimpedance amplifier (TIA) 1004, a clock-and-data recovery circuit (CDR) 1006, a mixer/driver circuit 1008, and/or a wireless antenna 1010. The photodiode 1002 converts incoming optical signals to electrical signals, which are amplified by the TIA 1004. The CDR 1006 extracts timing information and recovers the data stream, repackaging packets from the optical channels for transmission on the wireless channels. The mixer/driver circuit 1008 modulates the data onto the appropriate wireless frequency band, and the antenna 1010 radiates the wireless signal toward the optical switch 702. For signals from the optical switch 702 to the transceiver 704, the conversion path between the wireless channels and the output lanes or ports includes an antenna 1012, a mixer/driver circuit 1014, a CDR 1016, a link driver circuit 1018, and a laser 1020 in one embodiment. The antenna 1012 receives wireless signals, which are demodulated by the mixer/driver circuit 1014. The CDR 1016 recovers timing and data, and the link driver circuit 1018 drives the laser 1020 to generate optical output signals. In In some embodiments, an interface between the optical switch 702 and the transceivers 704 can use beam-forming antennae to improve lane density at the periphery of the optical switch 702.

In some embodiments, the optical switch 702 includes a transceiver 1022 and an optical switching fabric 1024. The transceiver 1022 includes components similar to those used in the transceiver 704 for converting between wireless and optical signals, including antennas, mixer/driver circuits, CDR circuits, and optical interface components.

FIG. 11 illustrates an exemplary optical multiplexer, according to some aspects of the disclosure. In some embodiments, the optical switch 702 can further include an optical multiplexer 1102 providing electrical to optical conversion and N:M multiplexing/de-multiplexing between the transceiver 1022 and the optical switching fabric 1024. The optical multiplexer 1102 can aggregate multiple wireless channels onto fewer optical channels or distribute optical channels across multiple wireless channels depending on the direction of data flow.

Returning to FIG. 10, in some embodiments, the optical switch 702 is referred to as a “wireless optical switch” because it receives wireless signals from the transceivers 704, converts them to optical signals, and performs switching in the optical domain. This terminology reflects the hybrid nature of the switch, which interfaces with wireless communication channels on one side and optical switching fabric on the other side.

In some embodiments, the mixer and driver 1008 circuits provide an M-to-N mapping of optical channels onto the wireless channels or bands. The clock-data recovery 1006 repackages packets from the optical channels into packets on the wireless channels or bands. The drivers 1018 clock bits of the packets to the antenna 1010. The wireless interface between the transceiver 704 and the optical switch 702 may comprise N mixer and driver 1008 circuits, N drivers 1018, and N antenna 1010. The wireless interface can use a clock that is higher frequency (terahertz range) than the clock used on the optical fiber.

In some embodiments, the antenna 1012, mixer/driver circuit 1014, CDR 1016, and optical fiber driver circuit 1018 can operate similarly in the opposite direction of data flow. In some embodiments, one or more of the transceivers 704 is configured to input a single fiber that carries eight optical channels (e.g., laser lines) and maps/multiplexes these channels onto two wireless bands each carrying packets from four of the optical channels.

A computational or computing workload refers to the amount of processing that a computer system must complete within a given time period. This can involve executing various tasks, such as running applications, performing calculations, processing data, and handling user requests. Computational workloads may be assessed in terms of their intensity, complexity, and the resources they consume, such as CPU, GPU, memory, disk, and network bandwidth. For some computing workloads, the channels on an optical fiber to a particular transceiver can not be fully used. In other words, some of the laser lines on the fiber can not be modulated with data. In this situation, dynamic (i.e., responsive to operating conditions) remapping of optical channels to (fewer) wireless channels or bands may be carried out to reduce power consumption at the wireless interface to the optical switch 702. This dynamic remapping enables fractional bandwidth allocation (e.g., non-integer lane-to-die ratios), allowing a compute die to utilize only the precise wireless bandwidth required for a workload, powering down remaining lanes to minimize thermal impact.

For example, and in some embodiments, a particular computing workload can fully use all optical channels of an optical fiber and can benefit from configuring the wireless channels to 8:1 (eight channels each carrying packets from one optical channel) or to 4:2 (four wireless channels each multiplexed with packets from two optical channels. Power savings is achieved for a less bandwidth intensive workload by dynamically re-configuring the wireless interface to 2:4 (two wireless channels each multiplexed with packets from four optical channels).

In some embodiments, eight optical channels on an optical fiber is fully used by certain algorithms in a deep learning training or inference workload. A transceiver coupled to this optical fiber is dynamically reconfigured to map the eight optical channels onto four wireless channels to the switch, each carrying two multiplexed optical channels. The optical fiber use can then decrease as the system transitions to executing a different workload or a different algorithm within the deep learning workload. The transceiver can dynamically adjust to map the eight optical channels to two wireless channels each carrying four optical channels, or to two wireless channels each carrying two optical channels, depending on the extent of the falloff in optical fiber use.

Because the wireless channels provide collectively higher bandwidth than the optical fiber can carry, it is unnecessary to activate all of them to keep up with the optical traffic, and the most efficient (e.g., lowest BER) channels is selected for use on a per-transceiver basis. The lowest BER channels for each transceiver is identified post-manufacture utilizing known calibration mechanisms, or is determined by runtime profiling of the system.

In some embodiments, dynamic channel remapping can be performed by monitoring optical channel use and adjusting the mapping of optical channels to wireless channels based on use thresholds or workload changes. The transition from one mapping configuration to another (e.g., from 8:1 to 4:2 to 2:4) may be coordinated between the transceiver 704 and the optical switch 702 to maintain packet continuity during remapping transitions. The remapping process can involve buffering in-flight packets, reconfiguring the mixer/driver circuits for the new channel assignment, and resuming transmission on the new configuration.

In some embodiments, calibration procedures are performed post-manufacture to identify optimal wireless channel assignments for each transceiver 704. Bit error rate (BER) measurements may be performed for each potential channel configuration, and the results may be stored as calibration data for application during operation. Runtime profiling mechanisms can provide ongoing optimization by monitoring channel quality and adjusting channel assignments as conditions change. The calibration data can identify combinations of wireless channels that provide lowest BER for each transceiver, accounting for manufacturing variations and environmental factors.

In some embodiments, wireless channel establishment between transceivers 704 and the optical switch 702 can follow an initialization sequence including channel negotiation, synchronization, and handshaking. During initialization, the transceiver 704 and optical switch 702 can negotiate channel assignments based on available spectrum and calibration data. Synchronization mechanisms can align timing between the wireless transceivers to enable coherent data transmission. Handshaking protocols can confirm successful channel establishment before data transmission begins.

In some embodiments, the system can detect defective or failed compute dies through various monitoring mechanisms including error rate monitoring, bit error rate (BER) threshold detection, health check protocols, or timeout detection. Upon detecting a defective compute die, the system can dynamically remap wireless channels to optical channels to bypass the failed component. This defective die detection can serve as a trigger for dynamic channel remapping in addition to workload-based triggers. For example, if a compute die exhibits elevated error rates or fails to respond to health check queries, the system can automatically reconfigure the mapping of wireless channels to optical channels to exclude the defective die from the communication path.

In some embodiments, when a destination compute die is determined to be defective, the system can route communications originally intended for the defective die to a redundant compute die through the redundant die's respectively coupled wireless transceiver. The plurality of compute dies may include one or more redundant compute dies that can assume processing responsibilities when primary dies fail. The wireless transceiver coupled to the redundant compute die can receive the rerouted signals and deliver them to the redundant die for processing. The rerouting can occur transparently to upstream components, maintaining system operation despite the compute die failure. This redundancy capability can improve manufacturing yield by allowing packages with some defective chiplets to remain functional.

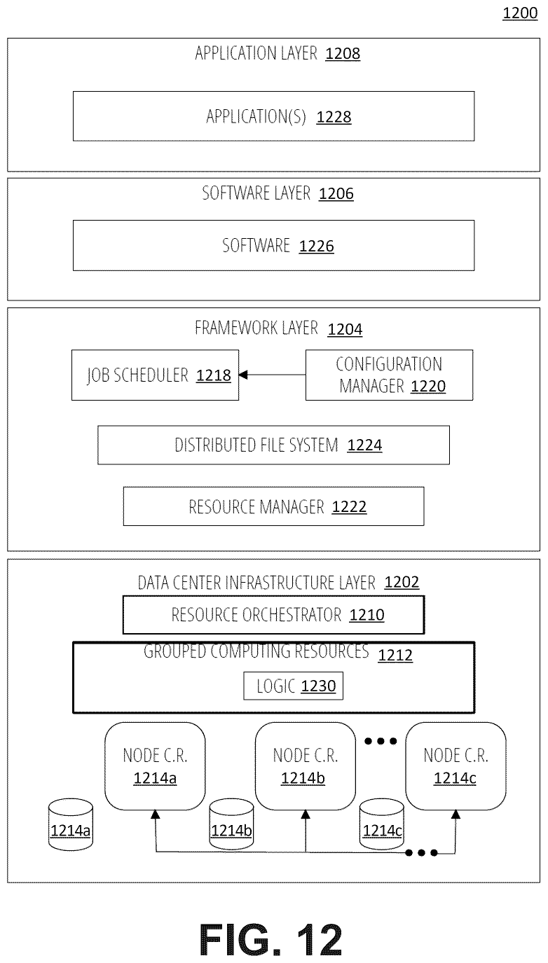

FIG. 12 illustrates an exemplary data center 1200 according to some aspects of the disclosure. In some embodiments, data center 1200 includes, without limitation, a data center infrastructure layer 1202, a framework layer 1204, a software layer 1206, and an application layer 1208.

In some embodiments, as illustrated in FIG. 12, data center infrastructure layer 1202 includes a resource orchestrator 1210, grouped computing resources 1212, and node computing resources (node C.R.s) 1214a, 1214b, 1214c, where “N” represents any whole, positive integer. In some embodiments, node computing resources includes, but are not limited to, any number of central processing devices (CPUs) or other processors (including accelerators, field programmable gate arrays (FPGAs), graphics processors, etc.), memory devices 1216a, 1216b, 1216c (e.g., dynamic random-access memory, solid state or disk drives, etc.), network input/output (NW I/O) devices, network switches, virtual machines (VMs), power modules, and cooling modules, etc. In some embodiments, one or more node computing resources from among node computing resources 1214a, 1214b, 1214c is a server having one or more of the above-mentioned computing resources.

In some embodiments, grouped computing resources 1212 includes separate groupings of node computing resources housed within one or more racks (not shown), or many racks housed in data centers at various geographical locations (also not shown). Separate groupings of node computing resources within grouped computing resources 1212 includes grouped compute network, memory, or storage resources that is configured or allocated to support one or more workloads. In some embodiments, several node computing resources including CPUs or processors is grouped within one or more racks to provide compute resources to support one or more workloads. In some embodiments, one or more racks can also include any number of power modules, cooling modules, and network switches (for example, co-packaged optical switches in accordance with the disclosed embodiments), in any combination.

In some embodiments, resource orchestrator 1210 can configure or otherwise control one or more node computing resources 1214a, 1214b, 1214c and/or grouped computing resources 1212. One or more of the node computing resources includes co-packaged compute chiplets in accordance with the disclosed embodiments. In some embodiments, resource orchestrator 1210 includes a software design infrastructure (“SDI”) management entity for data center 1200. In some embodiments, resource orchestrator 1210 includes hardware, software, or some combination thereof.

In some embodiments, as illustrated in FIG. 12, framework layer 1204 includes, without limitation, a job scheduler 1218, a configuration manager 1220, a resource manager 1222, and a distributed file system 1224. In some embodiments, framework layer 1204 includes a framework to support software 1226 of software layer 1206 and/or one or more application(s) 1228 of application layer 220. In some embodiments, software 1226 or application(s) 1228 can respectively include web-based service software or applications, such as those provided by Amazon Web Services, Google Cloud, and Microsoft Azure. In some embodiments, framework layer 1204 is, but is not limited to, a type of free and opensource software web application framework such as Apache SPARK™ (hereinafter “Spark) that can use a distributed file system 1224 for large-scale data processing (e.g., “big data”). In some embodiments, job scheduler 1218 includes a Spark driver to facilitate scheduling of workloads supported by various layers of data center 1200. In some embodiments, configuration manager 1220 is capable of configuring different layers such as software layer 1206 and framework layer 1204, including Spark and distributed file system 1224 for supporting large-scale data processing. In some embodiments, resource manager 1222 is capable of managing clustered or grouped computing resources mapped to or allocated for support of distributed file system 1224 and job scheduler 1218. In some embodiments, clustered or grouped computing resources includes grouped computing resources 1212 at data center infrastructure layer 1202. In some embodiments, resource manager 1222 can coordinate with resource orchestrator 1210 to manage these mapped or allocated computing resources.

In some embodiments, software 1226 included in software layer 1206 includes software used by at least portions of node computing resources 1214a, 1214b, 1214c, grouped computing resources 1212, and/or distributed file system 1224 of framework layer 1204. One or more types of software includes, but are not limited to, Internet web page search software, e-mail virus scan software, database software, and streaming video content software.

In some embodiments, application(s) 1228 included in application layer 1208 includes one or more types of applications used by at least portions of node computing resources 1214a, 1214b, 1214c, grouped computing resources 1212, and/or distributed file system 1224 of framework layer 1204. In at least one or more types of applications includes, without limitation, Compute Unified Device Architecture (CUDA) applications, 5G network applications, artificial intelligence applications, data center applications, and/or variations thereof. In some embodiments, one or more types of applications includes, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In some embodiments, any of configuration manager 1220, resource manager 1222, and resource orchestrator 1210 can implement any number and type of self-modifying actions based on any amount and type of data acquired in any technically feasible fashion. In some embodiments, self-modifying actions can relieve a data center operator of data center 1200 from making possibly bad configuration decisions and possibly avoiding underused and/or poorly performing portions of a data center.

In some embodiments, data center 1200 includes tools, services, software or other resources to train one or more machine learning models or predict or infer information using one or more machine learning models according to one or more embodiments described herein. For example, In some embodiments, a machine learning model is trained by calculating weight parameters according to a neural network architecture using software and computing resources described above with respect to data center 1200. In some embodiments, trained machine learning models corresponding to one or more neural networks is used to infer or predict information using resources described above with respect to data center 1200 by using weight parameters calculated through one or more training techniques described herein.

In some embodiments, data center 1200 can use CPUs, application-specific integrated circuits (ASICs), GPUs, FPGAs, or other hardware to perform training and/or inferencing using above-described resources. Moreover, one or more software and/or hardware resources described above is configured as a service to allow users to train or performing inferencing of information, such as image recognition, speech recognition, or other artificial intelligence services.

The grouped computing resources 1212 is configured with logic 1230 to implement the application(s) 1228. For example, the logic 1230 includes inference and/or training logic to perform deep learning inferencing and/or training operations associated with one or more embodiments. In some embodiments, logic 1230 can configure the data center 1200 for inferencing or predicting operations based, at least in part, on weight parameters calculated using neural network training operations, neural network functions and/or architectures, or neural network use cases described herein.

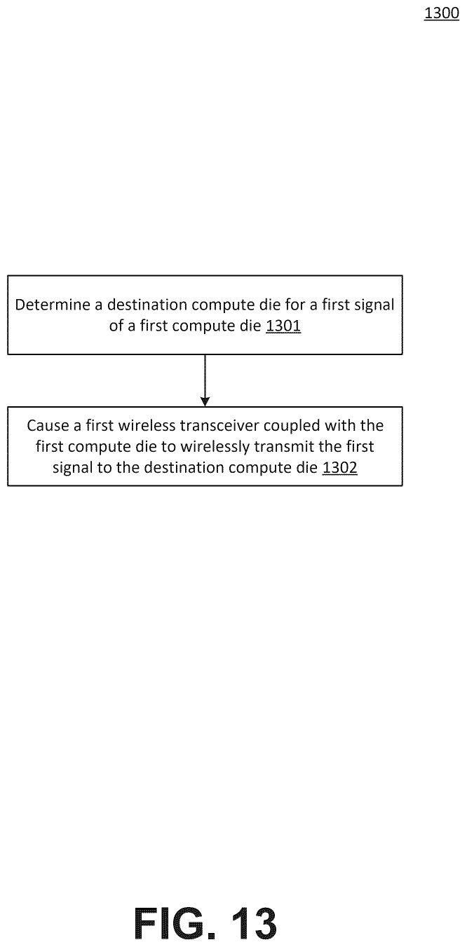

FIG. 13 is a flow diagram of an example method 1300 for wireless communication between compute dies in an optical communication network, according to aspects of the disclosure. The method 1300 can be performed by control logic that may include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 1301, the control logic performing the method 1300 determines a destination compute die for a first signal of a first compute die. In some embodiments, the destination compute die may be determined based on routing information contained within the first signal, such as a destination address or identifier associated with the destination compute die. In some embodiments, the destination compute die may be determined based on a routing table maintained by the control logic, wherein the routing table maps signal destinations to corresponding compute dies. In some embodiments, the first signal may comprise data packets, control signals, synchronization signals, or other types of signals to be communicated between compute dies. In some embodiments, the destination compute die is coupled with a destination wireless transceiver, which is one of many wireless transceivers. In some embodiments, the first compute die is coupled with a first wireless transceiver of the many wireless transceivers. In some embodiments, each wireless transceiver is configured to wirelessly communicate with other wireless transceivers of the many wireless transceivers, thus enabling wireless communication between the plurality of compute dies. In some embodiments, the wireless transceivers may operate in a terahertz-range or millimeter-wave frequency band to provide high-bandwidth communication between the compute dies. In some embodiments, the control logic may select a wireless channel for the transmission based on channel availability, signal quality, or bit error rate characteristics associated with the wireless channel.

At operation 1302, the control logic causes a first wireless transceiver coupled with the first compute die to wirelessly transmit the first signal to the destination compute die. In some embodiments, the first wireless transceiver may convert the first signal from an electrical format received from the first compute die into a wireless signal for transmission. In some embodiments, the conversion may involve modulating the first signal onto a carrier frequency within a terahertz-range or millimeter-wave frequency band using mixer and driver circuitry of the first wireless transceiver. In some embodiments, an antenna of the first wireless transceiver may radiate the wireless signal toward the destination wireless transceiver coupled with the destination compute die. In some embodiments, the antenna may be configured to provide directional transmission to reduce interference with other wireless channels within the package. In some embodiments, the destination wireless transceiver may receive the wireless signal via a corresponding antenna and demodulate the wireless signal to recover the first signal. In some embodiments, clock-and-data recovery circuitry of the destination wireless transceiver may extract timing information and recover the data stream from the received wireless signal. In some embodiments, the destination wireless transceiver may then deliver the recovered signal to the destination compute die via lanes coupling the destination wireless transceiver to the destination compute die. In some embodiments, the transmission may occur over a wireless channel selected based on calibration data identifying channels with favorable bit error rate characteristics. In some embodiments, the first wireless transceiver and the destination wireless transceiver may perform handshaking or synchronization operations prior to or during the transmission to ensure reliable data transfer.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal. The use of terms such as “first,” “second,” “third,” “fourth,” “fifth,” “sixth,” “seventh,” “eighth,” “ninth,” etc., are not intended to designate a particular order, unless specified.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some embodiments, code is stored on a computer-readable storage medium, for example, in form of a computer program comprising a plurality of instructions executable by one or more processors. In some embodiments, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some embodiments, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some embodiments, comprises multiple non-transitory computer-readable storage media and one or more of individual non-transitory storage media of multiple non-transitory computer-readable storage media lacks all of the code while multiple non-transitory computer-readable storage media collectively store all of the code. In some embodiments, executable instructions are executed such that different instructions are executed by different processors-for example, a non-transitory computer-readable storage medium stores instructions, and a main central processing unit (CPU) executes some of the instructions while a graphics processing unit (GPU) executes other instructions. In some embodiments, different components of a computer system have separate processors, and different processors execute different subsets of instructions.

Accordingly, in some embodiments, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A device comprising:
at least one processing device, comprising:
a plurality of compute dies; and
a plurality of wireless transceivers, each coupled to a respective one of the plurality of compute dies, wherein each wireless transceiver of the plurality of wireless transceivers is configured to wirelessly communicate with a plurality other wireless transceivers of the plurality of wireless transceivers, enabling wireless communication between the plurality of compute dies; and
an optical transceiver configured to:
communicate with at least one compute die of the at least one processing device via at least one wireless transceiver of the plurality of wireless transceivers, and
optically communicate with a plurality of external devices.

2. The device of claim 1, wherein each compute die of the plurality of compute dies comprises a first plurality of lanes, wherein each wireless transceiver of the plurality of wireless transceivers comprises a second plurality of lanes, and wherein each lane of the first plurality of lanes is operatively coupled to a corresponding lane of the second plurality of lanes through a configurable mapping.

3. The device of claim 2, wherein the at least one processing device is configured to dynamically remap the first plurality of lanes to the second plurality of lanes.

4. The device of claim 1, wherein the at least one processing device comprises one of a graphics processing device (GPU), a central processing device (CPU), a data processing device (DPU), or an application specific integrated circuit (ASIC).

5. The device of claim 1, wherein each compute die of the plurality of compute dies is coupled to a different wireless transceiver of the plurality of wireless transceivers.

6. The device of claim 1, wherein the optical transceiver is further configured to:
wirelessly communicate with the plurality of wireless transceivers; and
convert wireless signals received from the plurality of wireless transceivers into a plurality of corresponding optical signals.

7. The device of claim 1, wherein the optical transceiver comprises a first number of optical channels associated with a fiber interface and a second number of wireless channels associated with the plurality of wireless transceivers.

8. The device of claim 7, wherein the optical transceiver is configured to dynamically remap the second number of wireless channels onto the first number of optical channels.

9. The device of claim 8, wherein the dynamic remapping is performed responsive to identifying a defective compute die.

10. A system comprising:
an optical transceiver; and
at least one processing device operatively coupled with the optical transceiver, the at least one processing device comprising:
a plurality of compute dies;
a plurality of wireless transceivers, each coupled to a respective one of the plurality of compute dies, wherein each wireless transceiver of the plurality of wireless transceivers is configured to wirelessly communicate with a plurality of other wireless transceivers of the plurality of wireless transceivers, enabling wireless communication between the plurality of compute dies; and
control logic operatively coupled to the plurality of wireless transceivers, the control logic to perform operations comprising:
determining a destination transceiver of the plurality of wireless transceivers for a first signal transmission of a first wireless transceiver of the plurality of wireless transceivers, wherein the destination transceiver is one of the plurality of wireless transceivers or an optical transceiver; and
causing the first wireless transceiver to wirelessly transmit the first signal transmission to the destination transceiver.

11. The system of claim 10, wherein each compute die comprises a first plurality of lanes, wherein each wireless transceiver of the plurality of wireless transceivers comprises a second plurality of lanes, and wherein each lane of the first plurality of lanes is operatively coupled to a lane of the second plurality of lanes.

12. The system of claim 10, wherein the at least one processing device comprises one of a graphics processing device (GPU), a central processing device (CPU), a data processing device (DPU), or an application specific integrated circuit (ASIC).

13. The system of claim 10, wherein each compute die of the plurality of compute dies is coupled to a different wireless transceiver of the plurality of wireless transceivers.

14. The system of claim 10, further comprising:
the optical transceiver, wherein the optical transceiver is configured to:
communicate with at least one compute die of the at least one processing device via at least one wireless transceiver of the plurality of wireless transceivers, and
optically communicate with a plurality external devices.

15. The system of claim 14, wherein the optical transceiver is further configured to:
wirelessly communicate with the plurality of wireless transceivers; and
convert wireless signals received from the plurality of wireless transceivers into a plurality of corresponding optical signals.

16. The system of claim 10, wherein the optical transceiver comprises a first number of optical channels associated with a fiber interface and a second number of wireless channels associated with the plurality of wireless transceivers.

17. A method comprising:
determining a destination compute die of a plurality of compute dies for a first signal of a first compute die, wherein the destination compute die is coupled with a destination wireless transceiver of a plurality of wireless transceivers and the first compute die is coupled with a first wireless transceiver, wherein each wireless transceiver of the plurality of wireless transceivers is configured to wirelessly communicate with other wireless transceivers of the plurality of wireless transceivers, enabling wireless communication between the plurality of compute dies; and
causing the first wireless transceiver to wirelessly transmit the first signal to the destination wireless transceiver.

18. The method of claim 17, wherein each compute die comprises a first plurality of lanes, wherein each wireless transceiver of the plurality of wireless transceivers comprises a second plurality of lanes, and wherein each lane of the first plurality of lanes is operatively coupled to a lane of the second plurality of lanes.

19. The method of claim 17, wherein the plurality of compute dies include at least one of a graphics processing (GPU) die, a central processing device (CPU) die, a data processing device (DPU) die, or an application specific integrated circuit (ASIC) die.

20. The method of claim 17, further comprising:
determining that the destination compute die is a defective compute die; and
responsive to determining that the destination compute die is a defective compute die, causing the first wireless transceiver to wirelessly transmit the first signal to a redundant compute die of the plurality of compute dies via a respectively coupled wireless transceiver.

21. A wireless transceiver module comprising:
a plurality of antennae configured to transmit and receive millimeter-wave wireless signals;
a plurality of lanes configured to operatively couple the plurality of antennae to a corresponding plurality of lanes of a compute die of a plurality of compute dies; and
circuitry configured to convert between the millimeter-wave wireless signals at the plurality of antennae and signals transmitted via the plurality of lanes of the wireless transceiver module, wherein the wireless transceiver module is configured to wirelessly communicate with one or more other wireless transceiver modules, enabling a wireless communication fabric between the plurality of compute dies.
